(19) United States
(12) Patent Application Publication
(10) Pub. No.: US 2007/0272277 A1
(43) Pub. Date: Nov. 29, 2007

(54) Use of polymers in dishwashing compositions for the removal of grease and oil from plastic dishware, and dishwashing compositions

(76) Inventor: Brian Jeffreys, Grimbergen (BE)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/226,541

(22) Filed: Sep. 14, 2005

(30) Foreign Application Priority Data
Sep. 15, 2004 (EP) EP 04 077 543.9

(51) Int. Cl. B08B 3/04; C11D 3/16

(52) U.S. Cl. 134/25.2; 134/201; 510/235

(57) ABSTRACT

A method of making a dishwashing cleaning composition is disclosed. The method includes: providing ingredients for a dishwashing cleaning composition; providing a polymer selected from the group of: at least one first monomer and at least one second monomer, the first monomer being selected from the group of acrylate, substituted acrylate, maleate, or substituted maleate, and the second monomer being selected from styrene or substituted styrene, wherein the weight ratio of the first monomer to the second monomer is from 80:20 to 20:80; polyvinyl pyrrolidone; polyvinyl pyridine N-oxide; lignin-sulphonate; polyethylene-imine alkoxylates; and mixtures thereof; and combining the ingredients and the polymer to form a dishwashing cleaning composition that is capable of removing grease and oil from plastic dishware. In addition, a dishwashing cleaning composition is disclosed that comprises from 0.0001% to 5% by weight of the composition of a copolymer containing at least one first monomer and at least one second monomer, the first monomer being selected from the group of acrylate, substituted acrylate, maleate, or substituted maleate, and the second monomer being selected from styrene or substituted styrene, wherein the weight ratio of the first monomer to the second monomer is from 80:20 to 20:80, and from 10% to 60% by weight of the composition of a surfactant system, the surfactant system containing at least 0.5% by weight of the composition of an amine oxide. A kit including a container and the dishwashing composition, and a process of cleaning dishware using the dishwashing cleaning composition are also disclosed.

### FIELD OF THE INVENTION

The present invention relates to hand dishwashing compositions. Specifically, the present invention relates to enhancing the removal of grease and oil from plastic dishware.

### BACKGROUND OF THE INVENTION

The removal of grease and oil from dishware has been the object of research in the dishwashing area for a long time. While many current dishwashing products already provide improved removal of such soils from various types of surfaces such as metal, glass, or porcelain, there still remains a need for improving the removal of grease and oil from plastic dishware.

It has now been found that when plastic dishware is cleaned with existing dishwashing compositions, a thin film of grease or oil remains on the plastic surface. As such, the plastic dishware still feels greasy after cleaning, and/or has a mat appearance. As a result, the plastic dishware is perceived by consumers to still be dirty.

In addition, grease and oil found in difficult to reach areas of dishware, such as corners or narrow cracks, which is often the case with for example plastic containers, is often not removed with current existing dishwashing compositions.

Accordingly, the need exists for improving the grease and oil removal properties of dishwashing cleaning compositions, especially on plastic dishware. The need also exists for improving the appearance of the plastic dishware.

### SUMMARY OF THE INVENTION

The present invention relates to the use of certain polymers in dishwashing cleaning compositions for the removal of grease and oil from plastic dishware. These polymers are:
a) a copolymer comprising at least one first monomer and at least one second monomer, said first monomer being selected from the group of acrylate, substituted acrylate, maleate, or substituted maleate, and said second monomer being selected from styrene or substituted styrene, wherein the weight ratio of said first monomer to said second monomer is from 80:20 to 20:80;
b) polyvinyl pyrrolidone;
c) polyvinyl pyridine N-oxide;
d) lignin-sulphonate;
e) polyethylene-imine alkoxylates; and
f) mixtures thereof.

The present invention also relates to a dishwashing cleaning composition, comprising:
from 0.0001% to 5% by weight of the composition of a copolymer comprising at least one first monomer and at least one second monomer, said first monomer being selected from the group of acrylate, substituted acrylate, maleate, or substituted maleate, and said second monomer being selected from styrene or substituted styrene, wherein the weight ratio of said first monomer to said second monomer is from 80:20 to 20:80, and
from 10% to 60% by weight of the composition of a surfactant system, said surfactant system comprising at least 0.5% by weight of the composition of an amine oxide.

The present invention also relates to a kit comprising a container and the dishwashing composition, and to a process of cleaning dishware using the dishwashing cleaning composition.

### BRIEF DESCRIPTION OF THE DRAWINGS

FIG. 1 is a schematic drawing of how the slides are divided for the grease removal test.

### DETAILED DESCRIPTION OF THE INVENTION

### 1. Definitions

All percentages, ratios and proportions herein are by weight of the final dishwashing composition, unless otherwise specified. All temperatures are in degrees Celsius (° C.) unless otherwise specified.

As used herein, the term “dishware” means any tableware, cookware, glassware, cutlery, cutting board, food preparation equipment, etc. which is washed prior to or after contacting food, being used in a food preparation process and/or in the serving of food.

As used herein, the terms “foam” and “suds” are used interchangeably and indicate discrete bubbles of gas bounded by and suspended in a liquid phase.

As used herein, the term “microemulsion” means an oil-in-water emulsion which has the ability to emulsify oil into non-visible droplets. Such non-visible droplets typically have maximum diameter of less than 100 angstroms (Å), preferably less than 50 Å as measured by methods known in the art, such as ISO 7027 which measures turbidity at a wavelength of 880 nm. Turbidity measuring equipment is easily available from, for example, Omega Engineering, Inc., Stamford, Conn., U.S.A.

As used herein, the term “protomicroemulsion” means a composition which may be diluted with water to form a microemulsion.

### 2. Use of Polymers in a Dishwashing Cleaning Composition for Removing Grease and Oil from Plastic Dishware

It has been discovered that the following polymers improve the grease and oil removal properties of dishwashing cleaning composition, especially on plastic dishware. Therefore, according to a first aspect, the present invention relates to the use of these polymers in dishwashing cleaning compositions, for the removal of grease and oil from plastic dishware.

A first polymer which has been found to improve the grease and oil removal properties of dishwashing compositions, especially on plastic dishware, is a copolymer comprising at least one first monomer and at least one second monomer, which are chemically bonded together. The first monomer is selected from:
acrylates and substituted acrylates with the chemical structure —CH₂—C(R₁)—C(O)OR₂, wherein R₁═H or CH₃ and R₂═Li, Na, K or a C₁-C₆ aliphatic hydrocarbon chain; or
maleate and substituted maleates with the chemical structure: CH—(C(O)OR₃)—C(R₄)—C(O)OR₅,
wherein R₄═H or CH₃ and R₃, R₅═Li, Na, K or a C₁-C₆ aliphatic hydrocarbon chain.

The second monomer is selected from the group consisting of styrene and substituted styrenes having the chemical structure —CH₂—CR₁(C₆H₄R₂), wherein R₁═H or CH₃ and R₂═H, CH₃, or C₂H₅. Most the second monomer is selected from styrene, α-methyl styrene, or mixtures thereof.

Low levels of initiator or other components used to polymerize the monomers into copolymer can also be present in the copolymer raw material, and therefore in the dishwashing cleaning composition as well. Preferably, the polymerization or process aids comprise no more than 5%, most preferably no more than 2% by weight of the copolymer.

Polymerization of monomers to form the copolymers of the invention can be achieved by any method known in the art. The copolymers can consist of block copolymers, alternating monomer types, or anything in between. Useful polymerization processes and methods that are believed to be pertinent to the copolymers of the invention are disclosed in U.S. Pat. Nos. 5,122,568, 5,326,843, 5,886,076, 5,789,511, 6,548,752, Great Britain Patent No. 1 107 249, European Patent No. 0 636 687, and U.S. Patent Application No. 2003/0072950.

The weight ratio of the first monomer to the second monomer is from 80:20 to 20:80. A weight ratio greater than 80:20 results in polymers that are too hydrophilic, dissolve too quickly, and do not provide the desired improvements in removing grease and oil from plastic. A weight ratio lower than 20:80 results in polymers that are excessively hydrophobic, have poor solubility properties and do not remove grease and oil from plastic. Preferably, the weight ratio of the first monomer to the second monomer is from 70:30 to 30:70, more preferably from 60:40 to 40:60, and most preferably 50:50. One suitable example of a commercially available copolymer according to the invention is Alcosperse 747®, manufactured and sold by the Alco Chemical, a division of National Starch & Chemical Company (909 Mueller Drive, Chattanooga, Tenn. 37406, USA).

Other polymers which have been found to improve the grease and oil removal properties of dishwashing compositions, especially on plastic dishware are polyvinyl pyrrolidone, polyvinyl pyridine N-oxide, and polyethylene-imine alkoxylates. Another polymer suitable in the present invention is a lignin-sulphonate having the chemical structure: 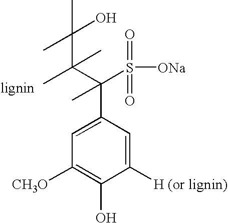
A preferred lignin-sulphonate is lignin-sulphonic acid sodium salt.

Although all these polymers provide improved grease and oil removal from plastic dishware, most preferred are the copolymers described hereinabove as they are cheaper than the other polymers.

Molecular weight selection for the polymers of the present invention is important to achieve the desired benefits. It has been found that generally cleaning properties are improved with a higher average molecular weight. However, if the average molecular weight is too high, the dishwashing composition may become less stable. Therefore, the average molecular weight should be at least 3,000, but not more than 1,000,000. The average molecular weight is preferably between 4,000 and 700,000, more preferably between 5,000 and 500,000, even more preferably between 5,000 and 400,000.

Molecular weight as defined herein is measured using Gel Permeation Chromatography (GPC) using a polyacrylic acid standard. In GPC, there is both a mobile phase and a stationary phase. The mobile phase, comprising a solvent and a portion of the polymer, moves past the stationary phase, which through physical or chemical means temporarily retains some portion of the polymer, thus providing a means of separation. Both of these methods depend on distribution coefficients, relating the selective distribution of an analyte between the mobile phase and the stationary phase, where the analyte is the component being analyzed. The GPC approach utilizes columns containing finely divided, porous particles. Polymer molecules that are smaller than the pore sizes in the particles can enter the pores, and therefore have a longer path and longer transit time than larger molecules that cannot enter the pores. Motion in and out of the pores is statistical, being governed by Brownian motion. Thus, the larger molecules elute earlier in the chromatogram, while the smaller molecules elute later. More information on GPC can be found in Chromatography of Polymers: Characterization by SEC and FFF, T. Provder (ed.), American Chemical Society, Washington, DC, 1993.

When used in dishwashing cleaning compositions, the above polymers should preferably be present at a level, by weight of the composition, of 0.0001% to 5%, more preferably from 0.5% to 3%, even more preferably from 0.7% to 2%, and most preferably at a level of 1%.

In a preferred embodiment, the above polymers are used in a dishwashing cleaning composition which comprises from 10% to 60% by weight of the composition of a surfactant system, and the surfactant system should at least comprise 0.5% by weight of the composition of an amine oxide. In a highly preferred embodiment, the dishwashing cleaning composition comprises a surfactant system comprising an anionic surfactant, and at least 0.5% of an amine oxide.

Without being limited by theory, it is believed that in combination with the surfactant system the described polymers act to impede the formation of structured liquid crystal phases containing oil/grease, water and surfactant thereby ensuring a more efficient removal of the final traces of oil grease under dish washing conditions. By packing efficiently into the surfactant palisades, sections of the polymer provide sufficient change in the palisade curvature to permit reduced micelle packing and more efficient grease removal.

### 3. Dishwashing Cleaning Composition

According to a second aspect, the present invention relates to a dishwashing composition having improved grease and oil removal properties on plastic dishware. The dishwashing cleaning composition comprises:
from 0.0001% to 5% by weight of the composition of a copolymer comprising at least one first monomer and at least one second monomer, said first monomer being selected from the group of acrylate, substituted acrylate, maleate, or substituted maleate, and said second monomer being selected from styrene or substituted styrene, wherein the ratio of said first monomer to said second monomer is from 80:20 to 20:80, and
from 10% to 60% by weight of the composition of a surfactant system, said surfactant system comprising at least 0.5% by weight of the composition of an amine oxide.

Preferred levels of the copolymer, preferred weight ratio's for the first monomer to the second monomer, and preferred molecular weights, are the same as described above.

The dishwashing cleaning composition can be in the form of a liquid or a gel, or can be in the form of a protomicroemulsion or a microemulsion. A microemulsion or a protomicroemulsion cleaning and especially dishwashing composition typically also contains a low water-soluble oil having a solubility in water of less than 5,000 ppm, preferably from 0 part per million (ppm) to 1,500 ppm, by weight of the low water-soluble oil, and more preferably from 1 part per trillion to 100 ppm. Preferred low water-soluble oils useful herein include terpenes, isoparaffins, other oils having the above solubility, and a mixture thereof.

The dishwashing cleaning composition herein typically has a viscosity of less than 10 Pa·s, preferably from 0.01 Pa·s to 10 Pa·s, more preferably from 0.02 Pa·s to 5 Pa·s, even more preferably from 0.03 Pa·s to 1 Pa·s, and even more preferably from 0.05 Pa·s to 0.4 Pa·s.

The dishwashing cleaning composition herein typically includes also a solvent, and preferably one or more optional ingredients known in the art of dishwashing, such as enzymes, viscosity modifiers, diamines, carboxylic acids, polymeric suds stabilizers, builders, magnesium ions, chelating agents, hydrophobic block polymers, or organic and inorganic salts. The dishwashing cleaning composition will further preferably comprise one or more detersive adjuncts selected from the following: soil release polymers, polymeric dispersants, polysaccharides, abrasives, bactericides and other antimicrobials, tarnish inhibitors, dyes or pigments, buffers, antifungal or mildew control agents, insect repellents, perfumes, hydrotropes, thickeners, processing aids, suds boosters, brighteners, anti-corrosive aids, stabilizers, antioxidants, a pH controlling agent, a reducing or oxidizing bleach, an odor control agent, antioxidants and free radical inhibitors, and a mixture thereof.

Surfactant system—The surfactant system herein comprises at least 0.5% by weight of the composition of an amine oxide. Amine oxides are semi-polar nonionic surfactants and include water-soluble amine oxides containing one alkyl moiety of from 10 to 18 carbon atoms and 2 moieties selected from the group consisting of alkyl groups and hydroxyalkyl groups containing from 1 to 3 carbon atoms; water-soluble phosphine oxides containing one alkyl moiety of from 10 to 18 carbon atoms and 2 moieties selected from the group consisting of alkyl groups and hydroxyalkyl groups containing from 1 to 3 carbon atoms; and water-soluble sulfoxides containing one alkyl moiety of from 10 to 18 carbon atoms and a moiety selected from the group consisting of alkyl and hydroxyalkyl moieties of from 1 to 3 carbon atoms. Preferred amine oxide surfactants in particular include C₁₀-C₁₈ alkyl dimethyl amine oxides and C₈-C₁₂ alkoxy ethyl dihydroxy ethyl amine oxides. Preferably the amine oxide is present in the composition in an effective amount, from 0.5% to 20%, more preferably 0.5% to 15%, even more preferably still from 0.5% to 10%, by weight.

The surfactant system preferably further comprises an anionic surfactant, an additional amphoteric surfactant different from amine oxide, a cationic surfactant, a nonionic surfactant, a zwitterionic surfactant, or a mixture thereof, preferably an alkyl sulfate, an alkoxy sulfate, an alkyl sulfonate, an alkoxy sulfonate, an alkyl aryl sulfonate, a betaine or a derivative of aliphatic or heterocyclic secondary and ternary amine, a quaternary ammonium surfactant, an amine, a singly or multiply alkoxylated alcohol, an alkyl polyglycoside, a fatty acid amide surfactant, a C₈-C₂₀ ammonia amide, a monoethanolamide, a diethanolamide, an isopropanolamide, a polyhydroxy fatty acid amide and a mixture thereof. The surfactants useful herein may further be branched and/or linear, substituted or unsubstituted, as desired. See also “Surface Active Agents and Detergents” (Vol. I and II by Schwartz, Perry and Berch).

Other suitable, non-limiting examples of amphoteric detergent surfactants that are useful in the present invention include amido propyl betaines and derivatives of aliphatic or heterocyclic secondary and ternary amines in which the aliphatic moiety can be straight chain or branched and wherein one of the aliphatic substituents contains from 8 to 24 carbon atoms and at least one aliphatic substituent contains an anionic water-solubilizing group. Preferably these amphoteric surfactants, where present, are present in the composition in an effective amount, more preferably from 0.1% to 20%, even more preferably 0.1% to 15%, even more preferably still from 0.5% to 10%, by weight.

Suitable nonionic surfactants include the condensation products of aliphatic alcohols with from 1 to 25 moles of ethylene oxide. The alkyl chain of the aliphatic alcohol can either be straight or branched, primary or secondary, and generally contains from 8 to 22 carbon atoms. Particularly preferred are the condensation products of alcohols having an alkyl group containing from 10 to 20 carbon atoms with from 2 to 18 moles of ethylene oxide per mole of alcohol. The preferred alkylpolyglycosides have the formula R²O(CₙH₂ₙO)ₜ(glycosyl)ₓ, wherein R² is selected from the group consisting of alkyl, alkyl-phenyl, hydroxyalkyl, hydroxyalkylphenyl, and mixtures thereof in which the alkyl groups contain from 10 to 18, preferably from 12 to 14, carbon atoms; n is 2 or 3, preferably 2; t is from 0 to 10, preferably 0; and x is from 1.3 to 10, preferably from 1.3 to 3, most preferably from 1.3 to 2.7. The glycosyl is preferably derived from glucose. To prepare these compounds, the alcohol or alkylpolyethoy alcohol is formed first and then reacted with glucose, or a source of glucose, to form the glucoside (attachment at the 1-position). The additional glycosyl units can then be attached between their 1-position and the preceding glycosyl units 2-, 3-, 4- and/or 6-position, preferably predominantly the 2-position.

Fatty acid amide surfactants having the formula: 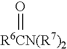
wherein R⁶ is an alkyl group containing from 7 to 21 (preferably from 9 to 17) carbon atoms and each R⁷ is selected from the group consisting of hydrogen, C₁-C₄ alkyl, C₁-C₄ hydroxyalkyl, and —(C²H₄O)ₓH where x varies from 1 to 3. Preferred amides are C₈-C₂₀ ammonia amides, monoethanolamides, diethanolamides, and isopropanolamides.

Preferably the nonionic surfactant, when present in the composition, is present in an effective amount, more preferably from 0.1% to 20%, even more preferably 0.1% to 15%, even more preferably still from 0.5% to 10%, by weight.

Anionic surfactants are preferred components of the compositions of the present invention. Suitable anionic surfactants for use in the compositions herein include water-soluble salts or acids of C₆-C₂₀ linear or branched hydrocarbyl, preferably an alkyl, hydroxyalkyl or alkylaryl, having a C₁₀-C₂₀ hydrocarbyl component, more preferably a C₁₀-C₁₄ alkyl or hydroxyalkyl, sulphate or sulphonates. Suitable counterions include H, alkali metal cation or ammonium or substituted ammonium, but preferably sodium. Where the hydrocarbyl chain is branched, it preferably comprises C1-4 alkyl branching units. The average percentage branching of the anionic surfactant is preferably greater than 30%, more preferably from 35% to 80% and most preferably from 40% to 60%. The anionic surfactant is preferably present at a level of at least 15%, more preferably from 20% to 40% and most preferably from 25% to 40% by weight of the total composition.

In a highly preferred embodiment, the surfactant system comprises an anionic surfactant, and at least 0.5% by weight of the composition of an amine oxide.

Solvent—The solvent useful herein is typically selected from the group consisting of water, alcohols, glycols, ether alcohols, and a mixture thereof, more preferably the group consisting of water, glycol, ethanol, glycol ethers, water, and a mixture thereof, even more preferably the group consisting of propylene carbonate, propylene glycol, tripropyleneglycol n-propyl ether, diethylene glycol n-butyl ether, water, and a mixture thereof. The solvent herein preferably has a solubility in water of at least 12%, more preferably of at least 50%, by weight of the solution. Solvents which are capable of decreasing the product viscosity and/or imparting a shear-thinning or non-Newtonian rheology profile to the compositions are especially preferred herein, as they may synergistically interact with the foam-generating dispenser to provide improved aesthetics, easier formulation, higher foam generation, easier pumpability, etc. Such solvents include mono, di and poly hydroxy alcohols, ethers, and mixtures thereof. Alkyl carbonates such as propylene carbonate are also preferred.

Enzyme—The enzyme useful herein includes a cellulase, a hemicellulase, a peroxidase, a protease, a gluco-amylase, an amylase, a lipase, a cutinase, a pectinase, a xylanase, a reductase, an oxidase, a phenoloxidase, a lipoxygenase, a ligninase, a pullulanase, a tannase, a pentosanase, a malanase, a β-glucanase, an arabinosidase and a mixture thereof. A preferred combination is a detergent composition having a cocktail of conventional applicable enzymes such as protease, amylase, lipase, cutinase and/or cellulase. An enzyme is typically present at from 0.0001% to 5% of active enzyme, by weight. Preferred proteolytic enzymes are selected from the group consisting of ALCALASE® (Novo Industri A/S), BPN′, Protease A and Protease B (Genencor), and mixtures thereof. Protease B is more preferred. Preferred amylase enzymes include TERMAMYL®, DURAMYL® and the amylase enzymes described in WO 94/18314 A1 to Antrim, et al., published on Aug. 18, 1994 (assigned to Genencor International) and WO 94/02597 A1 to Svendsen and Bisgard-Frantzen, published on Feb. 3, 1994 (assigned to Novo Nordisk A/S). Further non-limiting examples of preferred enzymes are disclosed in WO 99/63034 A1 to Vinson, et al., published on Dec. 9, 1999.

Viscosity modifier—The present compositions may comprise a viscosity modifier. Suitable viscosity modifiers include lower alkanols, glycols, C4-14 ethers and diethers, glycols or alkoxylated glycols, alkoxylated aromatic alcohols, aromatic alcohols, aliphatic branched alcohols, alkoxylated aliphatic branched alcohols, alkoxylated linear C1-C5 alcohols, linear C1-C5 alcohols, amines, C8-C14 alkyl and cycloalkyl hydrocarbons and halohydrocarbons, C6-C16 glycol ethers and mixtures thereof.

Preferred viscosity modifiers are selected from methoxy octadecanol, ethoxyethoxyethanol, benzyl alcohol, 2-ethylbutanol and/or 2-methylbutanol, 1-methylpropoxyethanol and/or 2-methylbutoxyethanol, linear C1-C₅ alcohols such as methanol, ethanol, propanol, isopropanol, butyl diglycol ether (BDGE), butyltriglycol ether, ter amilic alcohol, glycerol and mixtures thereof. Particularly preferred viscosity modifiers which can be used herein are butoxy propoxy propanol, butyl diglycol ether, benzyl alcohol, butoxypropanol, propylene glycol, glycerol, ethanol, methanol, isopropanol and mixtures thereof.

Other suitable viscosity modifiers for use herein include propylene glycol derivatives such as n-butoxypropanol or n-butoxypropoxypropanol, water-soluble CARBITOL R viscosity modifiers or water-soluble CELLOSOLVE R viscosity modifiers; water-soluble CARBITOL R viscosity modifiers are compounds of the 2-(2-alkoxyethoxy)ethanol class wherein the alkoxy group is derived from ethyl, propyl or butyl; a preferred water-soluble carbitol is 2-(2-butoxyethoxy)ethanol also known as butyl carbitol. Water-soluble CELLOSOLVE R viscosity modifiers are compounds of the 2-alkoxyethoxy ethanol class, with 2-butoxyethoxyethanol being preferred. Other suitable viscosity modifiers include benzyl alcohol, and diols such as 2-ethyl-1,3-hexanediol and 2,2,4-trimethyl-1,3-pentanediol and mixtures thereof. Some preferred viscosity modifiers for use herein are n-butoxypropoxypropanol, BUTYL CARBITOL Ò and mixtures thereof.

The viscosity modifiers can also be selected from the group of compounds comprising ether derivatives of mono-, di- and tri-ethylene glycol, butylene glycol ethers, and mixtures thereof. The molecular weights of these viscosity modifiers are preferably less than 350, more preferably between 100 and 300, even more preferably between 115 and 250. Examples of preferred viscosity modifiers include, for example, mono-ethylene glycol n-hexyl ether, mono-propylene glycol n-butyl ether, and tri-propylene glycol methyl ether. Ethylene glycol and propylene glycol ethers are commercially available from the Dow Chemical Company under the tradename “Dowanol” and from the Arco Chemical Company under the tradename “Arcosolv”. Other preferred viscosity modifiers including mono- and di-ethylene glycol n-hexyl ether are available from the Union Carbide company.

When present the composition will preferably contain at least 0.01%, more preferably at least 0.5%, even more preferably still, at least 1% by weight of the composition of viscosity modifier. The composition will also preferably contain no more than 20%, more preferably no more than 10%.

These viscosity modifiers may be used in conjunction with an aqueous liquid carrier, such as water, or they may be used without any aqueous liquid carrier being present. Viscosity modifiers are broadly defined as compounds that are liquid at temperatures of 20° C.-25° C. and which are not considered to be surfactants. One of the distinguishing features is that viscosity modifiers tend to exist as discrete entities rather than as broad mixtures of compounds.

Diamine—Another optional although preferred ingredient of the compositions according to the present invention is a diamine. Since the habits and practices of the users of detergent compositions show considerable variation, the composition will preferably contain at least 0.1%, more preferably at least 0.2%, even more preferably, at least 0.25%, even more preferably still, at least 0.5% by weight of said composition of diamine. The composition will also preferably contain no more than 15%, more preferably no more than 10%, even more preferably, no more than 6%, even more preferably, no more than 5%, even more preferably still, no more than 1.5% by weight of said composition of diamine.

Preferred organic diamines are those in which pK1 and pK2 are in the range of 8.0 to 11.5, preferably in the range of 8.4 to 11, even more preferably from 8.6 to 10.75. Preferred materials for performance and supply considerations are 1,3-bis(methylamine)-cyclohexane (pKa=10 to 10.5), 1,3 propane diamine (pK1=10.5; pK2=8.8), 1,6 hexane diamine (pK1=11; pK2=10), 1,3 pentane diamine (Dytek EP) (pK1=10.5; pK2=8.9), 2-methyl 1,5 pentane diamine (Dytek A) (pK1=11.2; pK2=10.0). Other preferred materials are the primary/primary diamines with alkylene spacers ranging from C4 to C8. In general, it is believed that primary diamines are preferred over secondary and tertiary diamines.

Definition of pK1 and pK2—As used herein, “pKa1” and “pKa2” are quantities of a type collectively known to those skilled in the art as “pKa” pKa is used herein in the same manner as is commonly known to people skilled in the art of chemistry. Values referenced herein can be obtained from literature, such as from “Critical Stability Constants: Volume 2, Amines” by Smith and Martel, Plenum Press, NY and London, 1975. Additional information on pKa's can be obtained from relevant company literature, such as information supplied by Dupont, a supplier of diamines. As a working definition herein, the pKa of the diamines is specified in an all-aqueous solution at 25° C. and for an ionic strength between 0.1 to 0.5 M.

Carboxylic acid—The compositions according to the present invention may comprise a linear or cyclic carboxylic acid or salt thereof to improve the rinse feel of the composition. The presence of anionic surfactants, especially when present in higher amounts in the region of 15-35% by weight of the composition, results in the composition imparting a slippery feel to the hands of the user and the dishware. This feeling of slipperiness is reduced when using the carboxylic acids as defined herein i.e. the rinse feel becomes draggy.

Carboxylic acids useful herein include C1-6 linear or at least 3 carbon containing cyclic acids. The linear or cyclic carbon-containing chain of the carboxylic acid or salt thereof may be substituted with a substituent group selected from the group consisting of hydroxyl, ester, ether, aliphatic groups having from 1 to 6, more preferably 1 to 4 carbon atoms and mixtures thereof.

Preferred carboxylic acids are those selected from the group consisting of salicylic acid, maleic acid, acetyl salicylic acid, 3 methyl salicylic acid, 4 hydroxy isophthalic acid, dihydroxyfumaric acid, 1,2, 4 benzene tricarboxylic acid, pentanoic acid and salts thereof and mixtures thereof. Where the carboxylic acid exists in the salt form, the cation of the salt is preferably selected from alkali metal, alkaline earth metal, monoethanolamine, diethanolamine or triethanolamine and mixtures thereof.

The carboxylic acid or salt thereof is preferably present at the level of from 0.1% to 5%, more preferably from 0.2% to 1% and most preferably from 0.25% to 0.5%.

Polymeric suds stabilizer—The compositions of the present invention may optionally contain a polymeric suds stabilizer. These polymeric suds stabilizers provide extended suds volume and suds duration without sacrificing the grease cutting ability of the liquid detergent compositions. These polymeric suds stabilizers are selected from: i) homopolymers of (N,N-dialkylamino)alkyl acrylate esters having the formula: 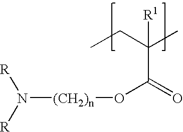
wherein each R is independently hydrogen, C₁-C₈ alkyl, and mixtures thereof, R¹ is hydrogen, C₁-C₆ alkyl, and mixtures thereof, n is from 2 to 6; and ii) copolymers of (i) and 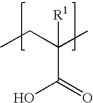
wherein R¹ is hydrogen, C1-C6 alkyl, and mixtures thereof, provided that the ratio of (ii) to (i) is from 2 to 1 to 1 to 2; The molecular weight of the polymeric suds boosters, determined via conventional gel permeation chromatography, is from 1,000 to 2,000,000, preferably from 5,000 to 1,000,000, more preferably from 10,000 to 750,000, more preferably from 20,000 to 500,000, even more preferably from 35,000 to 200,000. The polymeric suds stabilizer can optionally be present in the form of a salt, either an inorganic or organic salt, for example the citrate, sulfate, or nitrate salt of (N,N-dimethylamino)alkyl acrylate ester.

One preferred polymeric suds stabilizer is (N,N-dimethylamino)alkyl acrylate esters, namely

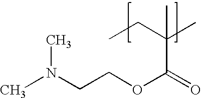

When present in the compositions, the polymeric suds booster may be present in the composition from 0.01% to 15%, preferably from 0.05% to 10%, more preferably from 0.1% to 5%, by weight.

Builder—The compositions according to the present invention may further comprise a builder system. If it is desirable to use a builder, then any conventional builder system is suitable for use herein including aluminosilicate materials, silicates, polycarboxylates and fatty acids, materials such as ethylene-diamine tetraacetate, metal ion sequestrants such as aminopolyphosphonates, particularly ethylenediamine tetramethylene phosphonic acid and diethylene triamine pentamethylene-phosphonic acid. Though less preferred for obvious environmental reasons, phosphate builders can also be used herein.

Suitable polycarboxylates builders for use herein include citric acid, preferably in the form of a water-soluble salt, derivatives of succinic acid of the formula R—CH(COOH)CH₂(COOH) wherein R is C₁₀₋₂₀ alkyl or alkenyl, preferably C₁₂₋₁₆, or wherein R can be substituted with hydroxyl, sulfo sulfoxyl or sulfone substituents. Specific examples include lauryl succinate, myristyl succinate, palmityl succinate 2-dodecenylsuccinate, 2-tetradecenyl succinate. Succinate builders are preferably used in the form of their water-soluble salts, including sodium, potassium, ammonium and alkanolammonium salts. Other suitable polycarboxylates are oxodisuccinates and mixtures of tartrate monosuccinic and tartrate disuccinic acid such as described in U.S. Pat. No. 4,663,071.

Especially for the liquid execution herein, suitable fatty acid builders for use herein are saturated or unsaturated C₁₀₋₁₈ fatty acids, as well as the corresponding soaps. Preferred saturated species have from 12 to 16 carbon atoms in the alkyl chain. The preferred unsaturated fatty acid is oleic acid. Other preferred builder system for liquid compositions is based on dodecenyl succinic acid and citric acid.

If detergency builder salts are included, they will be included in amounts of from 0.5% to 50% by weight of the composition preferably from 0.5% to 25% and most usually from 0.5% to 5% by weight.

Magnesium ions—The presence of magnesium ions in the dishwashing composition offers several benefits. Notably, the inclusion of such divalent ions improves the cleaning of greasy soils for various hand dishwashing liquid compositions, in particular compositions containing alkyl ethoxy carboxylates and/or polyhydroxy fatty acid amide. This is especially true when the compositions are used in softened water that contains few divalent ions. Preferably, the magnesium ions are added as a hydroxide, chloride, acetate, sulfate, formate, oxide or nitrate salt to the compositions of the present invention. If they are to be included in an alternate embodiment of the present compositions, then the magnesium ions are present at an active level of from 0.01% to 1.5%, preferably from 0.015% to 1%, more preferably from 0.025% to 0.5%, by weight.

Chelating Agents—The dishwashing compositions herein may also optionally contain one or more iron and/or manganese chelating agents. Such chelating agents can be selected from the group consisting of amino carboxylates, amino phosphonates, polyfunctionally-substituted aromatic chelating agents and mixtures therein, all as hereinafter defined. Without intending to be bound by theory, it is believed that the benefit of these materials is due in part to their exceptional ability to remove iron and manganese ions from washing solutions by formation of soluble chelates.

Amino carboxylates useful as optional chelating agents include ethylene diamine tetracetates, N-hydroxy ethyl ethylene diamine triacetates, nitrilo-tri-acetates, ethylenediamine tetraproprionates, triethylene tetraamine hexacetates, diethylene triamine pentaacetates, and ethanol diglycines, alkali metal, ammonium, and substituted ammonium salts therein and mixtures therein.

Amino phosphonates are also suitable for use as chelating agents in the compositions of the invention when at lease low levels of total phosphorus are permitted in detergent compositions, and include ethylene diamine tetrakis (methylene phosphonates) as DEQUEST. Preferred, these amino phosphonates to not contain alkyl or alkenyl groups with more than 6 carbon atoms. Polyfunctionally-substituted aromatic chelating agents are also useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene. A preferred biodegradable chelator for use herein is ethylenediamine disuccinate (“EDDS”), especially the [S,S] isomer as described in U.S. Pat. No. 4,704,233, Nov. 3, 1987, to Hartman and Perkins. The compositions herein may also contain water-soluble methyl glycine diacetic acid (MGDA) salts (or acid form) as a chelant or co-builder. Similarly, the so called “weak” builders such as citrate can also be used as chelating agents.

If utilized, these chelating agents will generally comprise from 0.00015% to 15% by weight of the detergent compositions herein. More preferably, if utilized, the chelating agents will comprise from 0.0003% to 3.0% by weight of such compositions.

Hydrophobic Block Polymer—The dishwashing composition may also optionally comprise a hydrophobic block polymer. The hydrophobic block polymer is defined as a block polymer having alkylene oxide moieties and average molecular weight of at least 500, but preferably less than 10,000, more preferably from 1,000 to 5,000 and most preferably from 1,500 to 3,500.

As is widely known in the art, the hydrophobicity of a polymer refers to its incompatibility with or insolubility in water. Suitable hydrophobic polymers have a water solubility of less than 1%, preferably less than 0.5%, more preferably less than 0.1% by weight at 25° C.

Moreover, suitable hydrophobic polymers may exhibit a CLogP value of greater than 1, preferably greater than 2, and more preferably greater than 2.5, but less than 40, preferably less than 20, and more preferably less than 6. In another embodiment, the ClogP value of the hydrophobic polymer in the present composition is from 2.5 to 6.

The ClogP value relates to the octanol/water partition coefficient of a material. Specifically, the octanol/water partition coefficient (P) is a measure of the ratio of the concentration of a particular polymer in octanol and in water at equilibrium. The partition coefficients are reported in logarithm of base 10 (i.e., logP). The logP values of many materials have been reported in the Pomona92 database, available from Daylight Chemical Information Systems, Inc. (hereinafter “Daylight CIS”), along with citations to the original literature. However, the logP values are most conveniently calculated by several “CLogP” programs widely available. For example, Daylight CIS has a “CLogP” program available. The United States Environmental Protection Agency also has available an Estimation Programs Interface for Windows (EPI-Win) that can be used to calculate the CLogP (or Log Kow). These programs also list experimental logP values when they are available in their respective databases. The preferred calculation tool is the EPI-Win model to calculate CLogP or LogKow based on polymer structures, primarily due to its versatility and user friendliness.

The “calculated logP” (ClogP) may be determined by the fragment approach of Hansch and Leo (cf., A. Leo, in Comprehensive Medicinal Chemistry, Vol. 4, C. Hansch, P. G. Sammens, J. B. Taylor and C. A. Ransden, Eds., p. 295, Pergamon Press, 1990). The fragment approach is based on the chemical structure of each molecule, taking into account the numbers and types of atoms, the atom connectivity, and chemical bonding. Other methods that may be used to compute ClogP include, e.g., Crippen's fragmentation method as disclosed in J. Chem. Inf. Comput. Sci., 27a, 21 (1987); Viswanadhan's fragmentation method as disclosed in J. Chem. Inf. Comput. Sci., 29, 163 (1989); and Broto's method as disclosed in Eur. J. Med. Chem.—Chim. Theor., 19, 71 (1984). It is understood by those skilled in the art that while experimental log P values could also be used, they represent a less preferred embodiment of the invention. When experimental log P values are used, the log P values at one hour are preferred.

“Block polymers” as used herein is meant to encompass polymers including two or more different homopolymeric and/or monomeric units which are linked to form a single polymer molecule. Typically, the block polymers are in the form of di-, tri- and multi-block polymers. Tri-block polymers have the basic structure ABA, wherein A and B are different homopolymeric and/or monomeric units. Di-block polymers are those having the basic structure ABAB, again wherein A and B are different homopolymeric and/or monomeric units. Those skilled in the art will recognize the phrase “block copolymers” is synonymous with this definition of “block polymers”.

“Building Blocks” herein is meant homopolymeric units and/or monomeric units that polymerize with one another to form block copolymers. Suitable building blocks in accordance with the present invention are alkylene oxide moieties. The different homopolymeric units present in block polymers retain some of their respective individual, original properties even though they are linked to one or more different homopolymeric units. Block polymers are known to exhibit properties that are different from those of homopolymers, random copolymers, and polymer blends. The properties of block copolymers themselves also differ depending on the length and chemical composition of the blocks making up the block polymer. Accordingly, the properties of a block polymer are influenced by the arrangement of the blocks within the block polymer. For example, a polymer such as “hydrophobic block-hydrophilic block-hydrophobic block”, will exhibit properties that are different than a block polymer such as “hydrophilic block-hydrophobic block-hydrophilic block”.

Preferred copolymers comprise ethylene oxide as one of the monomeric units. More preferred copolymers are those with ethylene oxide and propylene oxide. The ethylene oxide content of such preferred polymers is more than 5%, and more preferably more than 8%, but less than 50%, and more preferably less than 30%. A preferred polymer is ethylene oxide/propylene oxide copolymer available from BASF under the tradename Pluronic. Of those materials, Pluronic L81 is a specifically preferred polymer having an average molecular weight of 2750 and comprising on average 10% ethylene oxide and 90% propylene oxide units (according to supplier specifications). Another preferred polymer has an average molecular weight of 1750 and comprises on average 30% ethylene oxide and 70% propylene oxide units.

Preferred examples of such polymers are copolymeric glycols comprising alkylene oxide moieties preferably selected from combinations of ethylene oxide (EO), propylene oxide (PrO), butylene oxide (BO), pentylene oxide (PeO) and hexylene oxide (HO) moieties. However where ethylene oxide moieties are present they are preferably present in combination with another more hydrophobic moiety, for example propylene oxide or butylene oxide. Preferred copolymers are formed by adding blocks of polyethylene oxide moieties to the ends of polyalkylene glycol chains, with initiators that are commonly used for this reaction as known in the art. The preparation of block polymers is well known to polymer manufacturers and is not the subject of the present invention.

Preferred copolymers are readily biodegradable under aerobic conditions. Aerobic biodegradation is measured by the production of carbon dioxide (CO₂) from the test material in the standard test method as defined by Method 301B test guidelines of the Organization for Economic Cooperation and Development (OECD). The preferred polymers should achieve at least 60% of biodegradation as measured by CO₂ production in 28 days in the standard Method 301B. These OECD test method guidelines are well know in the art and cited herein as a reference (OECD, 1986).

Hydrophobic block polymers are preferably present in the composition at more than 0.05%, more preferably at least 0.1%, most preferably at least 0.2% by weight of the composition. The composition will also preferably contain no more than 10%, more preferably no more than 5%, most preferably no more than 3% by weight of the composition of hydrophobic polymer.

Organic and Inorganic Salts—The present composition may also comprise a short-chain organic salt, inorganic salt or mixtures thereof. Said short-chain organic salts can be either aliphatic salts or aromatic salts or mixtures hereof and is preferably selected from the group consisting of alkali metal salt and/or alkali earth metal salts of short-chain alkyl-or aryl carboxylic acids comprising a hydrocarbyl chain of no more than 7 carbons. Most preferably the organic salt is sodium citrate. Said inorganic salts are selected from the group consisting an alkali metal salt and/or alkali earth metal salts of halides, with the most preferred being sodium chloride. Said organic or inorganic salt is preferably present in the composition at a level of from 0.1 to 5%, more preferably from 0.5 to 3%, and most preferably from 0.8 to 1.5% by weight of the composition.

Antioxidant—An antioxidant can be optionally added to the dishwashing compositions of the present invention. They can be any conventional antioxidant used in detergent compositions, such as 2,6-di-tert-butyl-4-methylphenol (BHT), carbamate, ascorbate, thiosulfate, monoethanolamine(MEA), diethanolamine, triethanolamine, etc. It is preferred that the antioxidant, when present, be present in the composition from 0.001% to 5% by weight.

Hand dishwashing compositions, protomicroemulsion compositions and microemulsion compositions useful in the present invention are known in the art, as described in, for example, WO 96/01305 A1 to Farnworth and Martin, published on Jan. 18, 1996; U.S. Pat. No. 5,854,187 to Blum, et al., issued on Dec. 29, 1998; U.S. Pat. No. 6,147,047 to Robbins, et al., issued on Nov. 14, 2000; WO 99/58631 A1 to Robbins, et al., published on Nov. 18, 1999; U.S. Pat. No. 4,511,488 to Matta, issued on Apr. 16, 1985; U.S. Pat. No. 5,075,026 to Loth, et al., issued on Dec. 24, 1991; U.S. Pat. No. 5,076,954 to Loth, et al., issued on Dec. 31, 1991; U.S. Pat. No. 05,082,584 to Loth, et al., issued on Jan. 21, 1992; U.S. Pat. No. 5,108,643 to Loth, et al., issued on Apr. 28, 1992; and co-pending U.S. Patent Application No. 60/451064 (P&G Case #AA614FP), to Ford, et al., entitled “Protomicroemulsion, Cleaning Implement Containing Same, And Method Of Use Therefor”, filed on Feb. 28, 2003; co-pending U.S. Patent Application No. 60/472941 (P&G Case #AA614P2), to Ford, et al., entitled “Protomicroemulsion, Cleaning Implement Containing Same, And Method Of Use Therefor”, filed on May 23, 2003; co-pending U.S. Patent Application No. 60/535912 (P&G Case #AA614P3), to Ford, et al., entitled “Protomicroemulsion, Cleaning Implement Containing Same, And Method Of Use Therefor”, filed on Jan. 12, 2004; and co-pending U.S. Patent Application No. 60/535916 (P&G Case #AA633FP), to Hutton and Foley, entitled “Protomicroemulsion, Cleaning Implement Containing Same, And Method Of Use Therefor”, filed on Jan. 12, 2004.

### 4. Kits Comprising a Container

According to another aspect, the present invention also relates to a kit comprising a container, and a dishwashing cleaning composition as described above, contained in the container.

The container useful herein has a hollow body for holding a dishwashing composition, and is typically a bottle or canister formed of plastic, glass, and/or metal, preferably a polymer or resin such as polyethylene, polypropylene, polyethylene terephthalate, polycarbonate, polystyrene, ethyl vinyl alcohol, polyvinyl alcohol, thermoplastic elastomer, and combinations thereof, although other materials known in the art may also be used. Such containers will typically hold from 100 mL to 2 L of liquid, preferably from 150 mL to 1.2 L of liquid, and more preferably from 200 mL to 1 L of liquid, and are well known for holding liquid consumer products. Such containers are widely available from many packaging suppliers.

Preferably, a foam-generating dispenser for generating foam, may be operatively attached to the container either directly or indirectly. When activated, the foam-generating dispenser generates foam and concurrently dispenses the foam/dishwashing composition from the container. The foam-generating dispenser may be formed as either integral with, or separate from the container. If formed separately, the foam-generating dispenser may attach to the container via methods known in the art such as by employing a transition piece, corresponding threaded male and female members, pressurized and non-pressurized seals, locking and snap-on parts, and/or other methods known in the art. Preferably, the foam-generating dispenser is attached to the container via a transition piece and/or with corresponding threaded male and female members which allow easy refilling.

Preferred containers and foam-generating dispensers are described in co-pending U.S. application Ser. No. 10/787342 (P&G Case #AA-615M), to Hutton et al., entitled “A cleaning kit and/or dishwashing kit containing a foam-generating dispenser and a cleaning and/or dishwashing composition”, filed on Feb. 26, 2004.

### 5. Process of Cleaning Dishware

The present invention also relates to a process for cleaning dishware. The dishware is contacted with a composition as described above. The composition may be applied to the dishware neat or in dilute form. Thus the dishware may be cleaned singly by applying the composition to the dishware and optionally but preferably subsequently rinsing before drying. Alternatively, the composition can be mixed with water in a suitable vessel, for example a basin, sink or bowl and thus a number of dishes can be cleaned using the same composition and water (dishwater). In a further alternative process the product can be used in dilute form in a suitable vessel as a soaking medium for, typically extremely dirty, dishware. As before the dishware can be optionally, although preferably, rinsed before allowing to dry. Drying may take place passively by allowing for the natural evaporation of water or actively using any suitable drying equipment, for example a cloth or towel.

### 6. Test Method

The purpose of the test is to measure the grease removal performance from plastic substrate of a dishwashing liquid. Grease removal is measured after soiled slides are immersed into a wash solution and washed for seven minutes. The gloss of the slide is measured before and after the soiling and washing procedure, the difference in gloss is used to determine if the slide is clean.

Step 1—Preparation of the slides, prior to testing—For the test, white Melamine slides (Rubbermaid—25×75 mm×2 mm thick, 8 per test) were used. Wear clean gloves (for example, disposable nitrile gloves) to avoid finger marks on the slide. Wash the slides, for example: apply 3 to 10 ml Fairy™ Liquid (P&G) on the soft yellow side of a Spontex™ washup sponge (Spontex Ltd., UK), poor 200 ml water (2 to 15 g/g, 46° C.) on the sponge and squeeze 3 to 6 times. Wipe the slide, with the soft yellow side of the sponge in contact with the slide: wipe the entire front surface of the slide and the entire back surface of the slide, 10 times each. Rinse the slides, for example by holding the slide for 30 seconds per side, under running tap water (water flow: 2 to 20 liters/minute, 2 to 15 gpg, 46° C.). Dry the slides with a paper towel. Then, soak the slides for 10 minutes in acetone at 20-25° C., take the slides out of the acetone, and let the acetone evaporate. Then, soak the slides for 10 minutes in ethanol at 20-25° C., take the slides out of the ethanol, and let the ethanol evaporate.

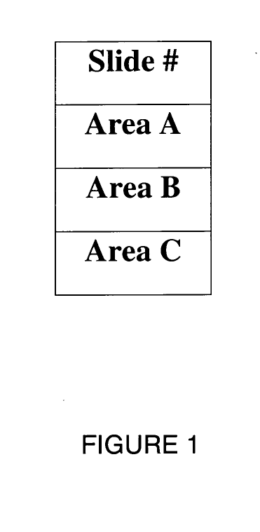

Step 2—Measure Initial Gloss—Place the slide on a flat horizontal surface. Draw a horizontal line 2 cm from the top of the slide. This area will not be soiled and will be used to clip the slides to the metallic holder. Divide the rest of the slide in 3 equal areas as shown in FIG. 1.

Measure and record the initial gloss of each area (A, B and C) of the slide, using the following procedure. For the test, a 162-Microgloss 60 gloss meter (Sheen Instruments Ltd—UK) was used. Before every use, the gloss meter must be calibrated. To measure the gloss of area A: activate the statistic mode and clear all stored data from previous measurements (see operating instructions), place the gloss meter on top of the area so that the opening for the light beam is in the middle of the area and in parallel with the horizontal line drawn at 2 cm from the top of the slide, activate the measurement by pressing the operate button, do not move the gloss meter from its position and activate a second time the measurement by pressing the operate button, the average of the two readings will be displayed in the display window (n=02), and record the average initial grade. Repeat this procedure to measure the gloss of Area B and C. Repeat all steps until the gloss of the 3 areas of all slides are measured. Repeat this procedure for all test slides.

Step 3—Soiling of the slides—Apply 100 μl of test soil (Pure corn oil, Mazola—Bestfoods Ltd., UK) on the slide with the micropipette (e.g. Transferpettor 50 μl-500 μl from BRAND Gmbh—Germany). Spread the oil equally across the slide, so that area A, B and C are covered, using a paint roll (e.g. mohair, 6.5 cm wide). (When starting a new paint roller it must be pre-conditioned with oil: Fill a 600 ml Schott Duran beaker (height: ±120 mm—width: ±90 mm) with 300 ml oil and immerse the paint roller in the oil for 5 seconds. Take the paint roller out the oil and let the excess drip off the paint roller for 1 to 2 minutes.) Put the slide, soiled side up, horizontally on a tray covered by towel paper. Repeat this procedure until all slides have been soiled.

Step, 4—Preparation of the washing solution—Weigh 1 g (±0.1 g) of a test dishwashing cleaning composition (see examples) in a 600 ml Schott Duran beaker (height: ±120 mm—width: ±90 mm) and add 499 g (±0.1 g) water of 7 g/g hardness at 20 to 25° C. Mix solution until complete product dissolution with a magnetic stirrer (e.g. digital hot plate/stirrer with temperature probe, type Ret-CV—IKA GmbH, Germany) using PTFE magnetic stirring bars (star type, 3.8 mm×3.8 mm) at 450 rpm during 5 minutes. Cover beakers with tinfoil to prevent evaporation.

Step 5—Washing and rinsing procedure—Clip 4 soiled slides, to the inside of a stainless steel metallic holder (height: ±105 mm (handles not included)—width: ±70 mm). Soiled side of slide will face the vortex when inserted into wash solution. Fill a Pyrex bowl (height: ±65 mm—width: ±160 mm) with 500 ml water (2 to 15 g/g) and heat it on a digital hot plate/stirrer with temperature probe to 46° C. (±0.1° C.). Add a magnetic stirrer (star type) in the 600 ml Schott Duran beaker containing the 500 g washing solution and put into the Pyrex bowl with the 500 ml water at 46° C. Check the temperature of the 500 g washing solution in the 600 ml Schott Duran beaker with a digital thermometer. When temperature of the 500 g washing solution in the 600 ml Schott Duran beaker reaches 46° C. (±0.1° C.), place the metallic holder with 4 soiled slides into wash solution and turn on the stirring at 450 rpm. Wash the slides for exactly 7 minutes. Fill a 2000 ml Schott Duran beaker (height: ±185 mm—width: ±140 mm) with 2000 ml de-mineralized water at 20 to 25° C. to rinse the washed slides. After 7 minutes of washing, remove the metallic holder with 4 slides out the washing solution and immerse the metallic holder with 4 slides during 5 seconds in the 2000 ml Schott Duran beaker with 2000 ml de-mineralized water at 20 to 25° C. Repeat the immersion of the metallic holder with 4 slides in the 2000 ml Schott Duran beaker with 2000 ml de-mineralized water at 20 to 25° C. another 2 times (3 immersions in total). Do not use the de-mineralized water for more than 3 immersions. Let the slides drain vertically, on the metallic holder for 1 minute, remove them and lay flat, soiled side up, to dry on a tray for 2 hours.

Steip 6—Results—Measure and record the gloss of each area of the washed slide using the same procedure as described above. Calculate the average difference in gloss grade per slide: the average of the difference per area between the initial gloss grade and the gloss grade after the washing procedure. When the average difference in gloss grade per slide is <10, the slide is clean. If the average difference in gloss is >10, the slide is not clean. To compare the grease cleaning performance of different products, the number of clean slides out of 8 slides washed is counted. The product with the highest amount of clean slides out 8 slides washed is the best performing. The product with the lowest amount of clean slides out of 8 slides washed is the poorest performing product.

### 7. EXAMPLES

### Example 1

The following compositions A to G were prepared (values are given in weight percent of total composition), and tested according to the test method described above:

| | Composition | | | | | | |
|---|---|---|---|---|---|---|---|
| | A | B | C | D | E | F | G |
| Sodium C₁₂ Alkyl Ethoxy_{0.6} Sulfate | 26.32 | 29.00 | 29.00 | 29.00 | 29.00 | 29.00 | 29.00 |
| C₁₂₋₁₄ Alkyl Dimethyl Amine Oxide | 5.70 | 6.50 | 6.50 | 6.50 | 6.50 | 6.50 | 6.50 |
| C₁₀ Alcohol Ethoxylated AE₈ | 1.99 | — | — | — | — | — | — |
| Nonionic surfactant | | | | | | | |
| C₁₀-C₁₆ alcohol ethoxylated | — | 2.50 | 2.50 | 2.50 | 2.50 | 2.50 | 2.50 |
| nonionic surfactant (Safol 23E3) | | | | | | | |
| Sudsing polymer¹ | 0.20 | 0.10 | 0.10 | 0.10 | 0.10 | 0.10 | 0.10 |
| diamine | 0.50 | 0.20 | 0.20 | 0.20 | 0.20 | 0.20 | 0.20 |
| Alcosperse 747² | — | — | 0.5 | 1 | 2 | — | — |
| PVP K-90³ | — | — | — | — | — | 1 | — |
| PVNO⁴ | — | — | — | — | — | — | 1 |

¹SB99 from Rhodia,
²from Alco Chemical,
³from BASF,
⁴from Reilly

The following table shows, for each composition, the average difference in gloss grade per slide, and the number of clean slides out of a total of 8 tested slides:

| Slide # | A | B | C | D | E | F | G |
|---|---|---|---|---|---|---|---|
| 1 | 19.3 | 16.4 | 10.0 | −1.4 | 3.6 | 5.5 | 9.2 |
| 2 | 10.1 | 16.4 | 8.9 | 37.6 | 3.1 | 9.8 | 6.0 |
| 3 | 8.9 | 29.5 | 18.4 | 7.0 | 7.0 | 18.5 | 13.7 |
| 4 | 20.0 | 52.5 | 24.3 | 5.7 | 9.2 | 9.1 | 15.1 |
| 5 | 23.8 | 23.1 | 14.8 | −3.8 | 9.5 | 8.6 | 9.3 |
| 6 | 24.7 | 22.8 | 1.2 | 10.7 | 5.5 | 12.4 | 11.5 |
| 7 | 17.6 | 29.3 | 2.6 | 12.0 | 5.0 | 19.0 | 9.0 |
| 8 | 29.5 | 25.4 | 7.2 | 6.0 | 4.4 | 30.4 | 9.9 |
| # clean slides/total slides | 1/8 | 0/8 | 4/8 | 5/8 | 8/8 | 4/8 | 5/8 |

From the data, it shows that compositions A and B (without the polymers of the present invention) do not provide a cleaning benefit on plastic tableware, whereas compositions C to G provide a significantly better cleaning performance.

### Example 2

The following compositions are examples of microemulsions according to the present invention. These compositions provide good grease and oil removal from plastic dishware.

| | H | I | J | K |
|---|---|---|---|---|
| Sodium C₁₂ Alkyl Ethoxy_{0.6} Sulfate | 22.5 | 22.5 | 28 | 28 |
| C₁₂₋₁₄ Alkyl Dimethyl Amine Oxide | 7.5 | 7.5 | 8.5 | 6.3 |
| C₈ Alcohol Ethoxylated Nonionic | 6.5 | 6.5 | 2.1 | 2.1 |
| surfactant | | | | |
| Poly(dimethylaminomethacrylate) | 0.2 | 0.2 | 0.3 | 0.2 |
| 1,3-bis(methylamine)-cyclohexane | 0.6 | 0.6 | 0.8 | 0.5 |
| MgCl2 Magnesium Chloride | 0.1 | — | 0.2 | — |
| Alcosperse 747 | 1.0 | 1.0 | 1.5 | 1.0 |
| Limonene | — | — | — | 10 |
| Terpineol | 1.5 | 1.5 | 4.0 | — |
| Ethanol | 6.0 | 6.0 | 8.0 | 3.0 |
| Propylene Glycol | 8.0 | 8.0 | 4.0 | 17 |
| Phenyl Propylene Glycol Ether | 8.0 | 8.0 | 4.0 | — |
| Water | bal. | bal. | bal. | bal. |

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A method of making a dishwashing cleaning composition, said method comprising;
providing ingredients for a dishwashing cleaning composition;
providing a polymer selected from the group consisting of:
a) a copolymer comprising at least one first monomer and at least one second monomer, said first monomer being selected from the group of acrylate, substituted acrylate, maleate, or substituted maleate, and said second monomer being selected from styrene or substituted styrene, wherein the weight ratio of said first monomer to said second monomer is from about 80:20 to about 20:80;
b) polyvinyl pyrrolidone;
c) polyvinyl pyridine N-oxide;
d) lignin sulphate;
e) polyethylene-imine; and
f) mixtures thereof; and
combining said ingredients and said polymer to form a dishwashing cleaning composition, wherein said dishwashing cleaning composition is capable of removing grease and oil from plastic dishware.

2. The method of claim 1 wherein the polymer is a copolymer comprising at least one first monomer and at least one second monomer, said first monomer being selected from the group of acrylate, substituted acrylate, maleate, or substituted maleate, and said second monomer being selected from styrene or substituted styrene, wherein said weight ratio of said first monomer to said second monomer is from about 70:30 to about 30:70.

3. The method of claim 2 wherein said weight ratio of said first monomer to said second monomer is about 50:50.

4. The method of claim 1 wherein the polymer has an average molecular weight from about 3,000 to about 1,000,000.

5. The method of claim 1 wherein the polymer has an average molecular weight from about 4,000 to about 700,000.

6. The method of claim 1 wherein the polymer is present in the dishwashing cleaning composition, at a level of from about 0.0001% to about 5% by weight of the composition.

7. The method of claim 1 wherein the dishwashing cleaning composition comprises from about 10% to about 60% by weight of the composition of a surfactant system, said surfactant system comprising at least about 0.5% by weight of the composition of an amine oxide.

8. A dishwashing cleaning composition comprising:
from about 0.0001% to about 5% by weight of the composition of a copolymer comprising at least one first monomer and at least one second monomer, said first monomer being selected from the group of acrylate, substituted acrylate, maleate, or substituted maleate, and said second monomer being selected from styrene or substituted styrene, wherein the weight ratio of said first monomer to said second monomer is from about 80:20 to about 20:80, and
from about 10% to about 60% by weight of the composition of a surfactant system, said surfactant system comprising at least about 0.5% by weight of the composition of an amine oxide.

9. A dishwashing cleaning composition according to claim 8, wherein said weight ratio of said first monomer to said second monomer is from about 70:30 to about 30:70.

10. A dishwashing cleaning composition according to claim 8, wherein said weight ratio of said first monomer to said second monomer is about 50:50.

11. A dishwashing cleaning composition according to claim 8, wherein the copolymer has an average molecular weight from about 3,000 to about 1,000,000.

12. A dishwashing cleaning composition according to claim 8, wherein the copolymer has an average molecular weight from about 4,000 to about 700,000.

13. A dishwashing cleaning composition according to claim 8, wherein the copolymer is present at a level of from about 0.5% to about 3% by weight of the composition.

14. A dishwashing cleaning composition according to claim 8, wherein the copolymer is present at a level of from about 0.7% to about 2% by weight of the composition.

15. (canceled)

16. A kit comprising:
a container; and
a dishwashing cleaning composition of claim 8 contained in said container.

17. A kit according to claim 16, further comprising instructions for use, said instructions comprising the use of the dishwashing cleaning composition for removing grease and oil from plastic dishware.
